(19) United States
(12) Patent Application Publication
(10) Pub. No.: US 2025/0266569 A1
(43) Pub. Date: Aug. 21, 2025

(54) BATTERY ARRANGEMENT WITH A FIRE PROTECTION ELEMENT BETWEEN A BATTERY MODULE AND A HOUSING COMPONENT, AND METHOD FOR PRODUCING A FIRE PROTECTION ELEMENT

(71) Applicant: AUDI AG, Ingolstadt (DE)

(72) Inventor: Julius RAUSCH, Heilbronn (DE)

(73) Assignee: AUDI AG, Ingolstadt (DE)

(21) Appl. No.: 19/016,462

(22) Filed: Jan. 10, 2025

(30) Foreign Application Priority Data
Feb. 15, 2024 (DE) 102024104284.2

(51) Int. Cl. H01M 50/383; H01M 50/209; H01M 50/317; H01M 50/342

(52) U.S. Cl. CPC H01M 50/383; H01M 50/209; H01M 50/317; H01M 50/3425; H01M 2200/20

(57) ABSTRACT

A battery arrangement having a housing component and a battery module, which includes at least one battery cell and a first module side which faces the housing component. The first module side has a degassing region in which at least one releasable cell degassing opening of the at least one battery cell is arranged. The housing component includes a passage region which has at least one at least releasable opening, which is opposite the at least one releasable cell degassing opening. A fire protection element is arranged in an intermediate space between the degassing region and the passage region, which element covers the at least releasable opening and the releasable cell degassing opening. The fire protection element is formed with an elastic foam injection molding layer and comprises at least two regions which differ in at least one property.

### FIELD

The invention relates to a battery module arrangement with a housing component and a battery module which comprises at least one battery cell and a first module side which faces the housing component, wherein the first module side has a degassing region in which at least one releasable cell degassing opening of the at least one battery cell is arranged. The housing component further comprises a passage region which comprises at least one at least releasable opening, wherein the passage region is directly opposite the degassing region in such a way that the at least one at least releasable opening is opposite the at least one releasable cell degassing opening. Furthermore, the invention also relates to a method for producing a fire protection element.

### BACKGROUND

Battery systems, for example high-voltage battery systems for motor vehicles, often provide for thermal outgassing of the battery cell into a connected volume in the event of damage, for example in the event of thermal runaway of a battery cell of such a battery. This volume can also be referred to as the interior of a degassing channel. The respective battery cells can have a corresponding releasable cell degassing opening. This is typically located in the cell housing and opens depending on the pressure to allow controlled outgassing in the event of excess pressure in the battery cell. The gas escaping from such a battery cell can, for example, be introduced into the interior of such a degassing channel through a corresponding passage opening in a degassing channel wall, such as through the above-mentioned at least releasable opening in the housing component. The degassing channel wall should be connected to a battery module in such a way that the passage opening of the degassing channel wall is connected as directly as possible to the releasable cell degassing opening of the battery cell of such a battery module. Often, multiple prismatic battery cells are located directly next to each other in a battery for the purpose of a space-saving arrangement. Likewise, the respective releasable cell degassing openings are then arranged directly next to each other and connected to such a degassing channel via respective inlet openings in it.

However, there are certain difficulties in implementing the most efficient gas discharge possible in the event of outgassing from a battery cell. On the one hand, the gas escaping from a thermally runaway battery cell and the tiny particles contained therein can pass through the smallest gaps and slits. Accordingly, there is a risk that part of this escaping gas will not reach the degassing channel, but may, for example, reach the neighboring cell directly through a gap between such a degassing channel wall and the battery cell. In the event of a thermal runaway of a cell, the gas could damage the bursting disk of the neighboring cell and cause it to thermally runaway. A further problem is that the gas entering such a degassing channel typically hits the opposite degassing channel wall of the degassing channel. In particular with a low construction height of such a degassing channel, a large part of the hot exhaust gases can be “reflected” by this opposite wall and radiated back in the direction of the cell and in particular the neighboring cell and can then also partially hit directly on the underside of the neighboring cells, which are also connected with their respective cell degassing openings to corresponding passage openings in the degassing channel wall. In order to allow easy opening and reliable outgassing of the battery cells, the releasable cell degassing openings of the battery cells are not particularly robustly designed and can easily be damaged by the reflected, abrasive gas jet. Accordingly, if a relevant cell outgasses, there is a risk that the neighboring cell may be damaged by the reflected gas jet, which can also lead to thermal runaway of the neighboring cells.

DE 10 2022 105 511 B3 describes a vehicle with a battery system and an underride guard plate which is arranged under the battery system, wherein the underride guard plate rests directly on the battery system in at least a first region and a second region in portions and is shaped such that a portion of a gas channel is formed between the battery system and the underride guard plate between the first and second regions. The battery system has degassing openings that open into the gas channel.

EP 4 228 067 A2 describes a battery with a multi-layer safety structure arranged below the battery cells. The safety structure includes an inner layer, an outer layer, and an intermediate layer connecting the inner layer and the outer layer to each other. The inner layer faces the battery cells. A degassing channel can be formed in the inner layer. The inner layer can be glued to the battery cells.

However, the problems mentioned above still remain.

### SUMMARY

The object of the present invention is therefore to provide a battery arrangement and a method which make gas discharge as efficient as possible in case of a thermal runaway of a battery cell and in particular reduce as much as possible the possibility of a thermal propagation to a neighboring cell.

A battery arrangement according to the invention comprises a housing component and a battery module which comprises at least one battery cell and a first module side which faces the housing component, wherein the first module side has a degassing region in which at least one releasable cell degassing opening of the at least one battery cell is arranged, and wherein the housing component comprises a passage region which comprises at least one at least releasable opening, wherein the passage region is directly opposite the degassing region in such a way that the at least one at least releasable opening is opposite the at least one releasable cell degassing opening. In this case, a fire protection element is arranged in an intermediate space between the degassing region and the passage region, which element covers the at least releasable opening and the releasable cell degassing opening, wherein the fire protection element is formed with an elastic foam injection molding layer and comprises at least two regions which differ in at least one property.

The invention is based on several findings: Firstly, by providing the fire protection element, which can also be referred to as a heat shield, between the degassing region of the first module side and the passage region of the housing component, various functions and properties can be provided which are particularly advantageous for efficient gas discharge and reducing the risk of thermal propagation. On the one hand, such a fire protection element can take on a sealing function, for example to prevent a gas escaping from the at least one cell degassing opening from reaching a neighboring cell through a gap or space between the housing component and the first module side. This fire protection element can, in particular due to its elastic properties, advantageously seal the releasable cell degassing opening and the opposite, at least releasable opening in the passage region of the housing component from one another. Furthermore, since the fire protection element covers both the releasable cell degassing opening and the at least releasable opening in the passage region, a certain protective function and shielding function for neighboring cells with regard to the reflected gases described above can be provided in the event of degassing of a battery cell. If, for example, gas escapes from a neighboring cell and hits an opposite degassing channel wall, so that at least a portion of this gas is reflected back, this reflected gas can advantageously be prevented from hitting the releasable cell degassing opening of the at least one battery cell directly, but instead hits the fire protection element that covers this releasable cell degassing opening. Furthermore, the invention is based on the realization that a fire protection element should have partially complementary properties in order to carry out the functions described, which would be inadequate or not at all realizable by a homogeneous material or a homogeneous structure of such a fire protection element. For example, in the event of outgassing of at least one battery cell, the fire protection element should be as easily penetrated as possible by the gas escaping from this battery cell in order not to impair the gas entry into the degassing channel. Conversely, the fire protection element should be as robust as possible, for example with respect to reflected, impinging gases, in order to protect the releasable cell degassing opening located above it. These apparent contradictions can be particularly advantageously resolved by the fire protection element also being designed with at least two regions which differ in at least one property with regard to their design. This means that the fire protection element can be optimally adapted to the tasks to be fulfilled thanks to these different properties.

In order to ensure the most efficient production of such a fire protection element with the greatest possible customization options, it is particularly advantageous if it is formed with an elastic foam injection molding layer. By means of such a foam injection molding layer, i.e. a layer made of an elastic foam material, which is manufactured in particular by means of a foam injection molding process, a wide variety of properties of such a foam injection molding layer, which can also be simply referred to as a foam layer, can be realized in a particularly simple manner during production. An injection molding process, for example, enables the formation of such a layer with a geometry that deviates from a pure cuboid geometry, and thus allows particularly advantageous geometric adaptation options that can be used, for example, to optimize the sealing function of the fire protection layer, i.e. the fire protection element. The degree of foaming of the foam material during the injection molding process can influence the elastic properties and compressibility of the fire protection element. In particular, different pore densities, elasticities and/or compressibilities can be set in certain regions. If required, the foam injection molding layer can also be provided with additional layers locally, for example by back-injection or by joining them using inserts in the injection molding process in order to locally provide the fire protection element with different properties, for example with locally increased fire protection properties. This means that a fire protection element with, if desired, a very complex property profile can be provided in a particularly simple and cost-effective manner and such a fire protection element can enable particularly efficient gas discharge and reduce the probability of thermal propagation to neighboring cells.

The housing component can, for example, be a degassing channel wall, as illustratively described at the beginning. Such a degassing channel, which can also optionally be part of the battery arrangement, can be delimited on one side by the housing component. On the side opposite the housing component, the degassing channel can be delimited by another degassing channel wall. The interior of the degassing channel can be defined between the two boundary walls of the degassing channel.

The housing component has the passage region, which comprises the at least one at least releasable opening. An at least releasable opening is to be understood as both a permanent opening, for example in the form of a hole, and an opening that is only released in the event of degassing, for example, by bursting and/or tearing and/or melting of a cover element closing the opening. Preferably, the at least releasable opening in the passage region is designed as a permanent opening in a plate-shaped component of the housing component, which is covered by a cover element, e.g. a thin membrane or layer, in particular a thin film, wherein such a cover or such a cover element can also be regarded as part of the housing component. This cover can be located on a side facing to or away from the battery module. However, such cover is only optional. Furthermore, the housing component can also comprise a plurality of such at least releasable openings in the passage region. In particular, the number of these at least releasable openings, which in the following are also sometimes referred to just as openings for the sake of simplicity without restricting generality, can correspond to a number of battery cells and releasable cell degassing openings. If the battery module comprises multiple battery cells, each with a releasable cell degassing opening, each of these releasable cell degassing openings can be located opposite a corresponding at least releasable opening in the passage region. The openings of the passage region can be spaced apart from each other.

The at least one battery cell is in particular a prismatic battery cell. It thus has an essentially cuboid geometry. The battery cells can be formed, for example, as lithium-ion cells. The battery module can furthermore also comprise a cell stack with a plurality of battery cells arranged next to one another in a stacking direction. Each of these battery cells then has, for example, a first cell side on which the respective releasable cell degassing opening of the respective battery cell is arranged. The first cell sides are all part of the first module side. The releasable cell degassing openings are then all arranged in the degassing region of the first module side. Furthermore, it is preferred that the releasable cell degassing openings are all located on a line that extends straight in the stacking direction. The same applies to the at least releasable openings in the passage region.

The releasable cell degassing opening can be designed, for example, as a pressure relief valve and/or as a bursting membrane or the like. The releasable cell degassing opening can also be referred to as a cell vent or vent or venting opening or the like.

If the battery module comprises multiple battery cells and the passage region accordingly comprises multiple at least releasable openings, it is preferred that the fire protection element extends over all of the at least releasable openings encompassed by the passage region, as well as over all of the releasable cell degassing openings in the degassing region of the first module side. However, this does not necessarily have to be the case. It is also conceivable that multiple fire protection elements are provided, which are then arranged next to one another, for example in the stacking direction, and each cover one or more releasable cell degassing openings and the corresponding opposite at least releasable openings in the passage region.

The fire protection element is elastic due to its elastic foam injection molding layer. In its intended position in the space between the degassing region and the passage region, the fire protection element is in an at least partially compressed and/or in a compressed state at least in regions. The fire protection element can also be compressed to varying degrees in certain regions. This allows the fire protection element to take on a sealing function and also to compensate for a certain degree of tolerances caused by manufacturing. The elastic foam injection molding layer therefore represents a foam layer which is formed, for example, from an elastic plastic foam or which comprises such an elastic plastic foam. This foam injection molding layer is therefore elastic, in particular permanently elastic, as well as porous. The foam injection molding layer can, for example, represent a foam injection molding mat or a foam mat. The foaming of this foam injection molding layer takes place during the injection molding process for producing this foam injection molding layer. Foaming can be carried out chemically and/or physically, e.g. by using a blowing agent introduced into the injection molding tool.

According to a further advantageous embodiment of the invention, the foam injection molding layer comprises a foamed, thermoplastic soft component, in particular thermoplastic elastomers and/or thermoplastic polyurethanes and/or thermoplastic vulcanizates. By using these thermoplastic soft components, which can also be called thermoplastic soft materials, as a base material or matrix material for the foam injection molding layer, the latter can advantageously be formed with elastic properties, in particular permanently elastic properties. The elasticity and/or compressibility of the foam injection molding layer is therefore not only determined by the porosity of the foam mat itself, but also by the elastic properties of the thermoplastic soft material used. The foam injection molding layer can also consist of only one or more such thermoplastic soft components, namely it does not have to include any additional components, such as fillers, although this is still possible.

For ease of description, three spatial directions are defined below, namely a first direction, a second direction and a third direction, which are perpendicular to each other in pairs. The first direction can correspond to said stacking direction. The third direction is defined in particular from the housing component in the direction of the battery module and corresponds with regard to a proper installation position in a motor vehicle, for example to the vertical direction of the vehicle. With respect to these defined directions, the at least two regions of the fire protection element, which differ in at least one property, can be arranged next to each other in the first direction and/or next to each other in the second direction and/or next to each other in the third direction. This provides numerous advantageous adjustment options.

According to an advantageous embodiment of the invention, the at least one property represents a porosity of the foam injection molding layer. The porosity, or more precisely the pore density of the foam injection molding layer, can in turn influence other properties of the layer, in particular its elasticity and/or compressibility. The higher the pore density, the more compressible and softer the foam injection molding layer is. A high pore density also leads to a high thermal resistance. The pore density can be defined in particular as the ratio of the total pore volume of the pores enclosed in the foam injection molding layer to the total volume of the foam injection molding layer in this defined region. This makes it possible, for example, to specifically form softer and harder regions and/or more and less compressible regions or similar.

According to a further advantageous embodiment of the invention, the at least one property represents a thickness of the fire protection element. This is particularly advantageous because it allows the penetration of venting gases into the fire protection layer to be influenced. By reducing the thickness, for example, a predetermined breaking point can be formed in the fire protection element, in particular specifically in the part of the fire protection element arranged between the releasable cell degassing opening and the releasable opening of the passage region. A variation in thickness also makes it possible to better adapt the fire protection element geometrically to the space between the degassing region and the passage region. This in turn enables an improved sealing function.

According to a further advantageous embodiment of the invention, the at least one property represents a layer structure of the fire protection element. This makes it possible, for example, to provide additional fire protection layers locally in order to ensure, for example, an improved shielding effect with regard to reflected gas components. In particular, the fire protection element can have different regions that differ in the number and/or type of layers of the fire protection element. Such layers are arranged one above the other, in particular with respect to the third direction defined above. One of these layers, which is present in particular in all regions of the fire protection element, is the foam injection molding layer.

This advantageously provides numerous adaptation options in order to design the fire protection layer in a way that is optimally adapted to the functions it is to fulfill differently in different locations.

According to a further advantageous embodiment of the invention, the fire protection element has a length in a first direction, in particular the first direction already defined above, a width in a second direction, in particular the second direction already defined above, and a thickness in a third direction, in particular the third direction already defined above. In this case, the fire protection element can have a central region and two edge regions with respect to the second direction, wherein a thickness of the fire protection element in the edge regions is in particular smaller than in the central region, and/or wherein the fire protection element has a thickness that varies in the first direction, in particular a thickness that varies periodically.

The fact that the fire protection element has a smaller thickness in the edge regions than in the central region with respect to the second direction has the advantage that the fire protection element can be better adapted geometrically to the existing intermediate space. The reason for this is that the housing component, which in particular provides the degassing channel wall, can simultaneously also be designed as a cooling device for cooling the battery module. It is therefore advantageous if the housing component is arranged as close as possible to and/or in contact with the first module side, in particular in regions that do not represent the passage region, in particular in regions that do not represent the degassing region, for example via a thermally conductive adhesive and/or a gap filler. The distance between the housing component and the first module side can therefore be slightly larger in the passage region than in other regions of the housing component. The space between the first module side and the housing component tapers accordingly with respect to the second direction towards the edge regions of this space. This can be advantageously taken into account by the reduced thickness of the fire protection element in the edge regions.

Due to the varying thickness of the fire protection element in the first direction, it is advantageously possible to adapt the fire protection element geometrically better to so-called gusset regions between two adjacent battery cells. In particular, prismatic battery cells can have a cell housing with rounded edges. In addition, a cell separating element can be arranged between each two adjacent cells, which does not completely fill the space between the two cells but ends, for example, where the rounded edges of the cells begin, so that the cell separating element has a certain distance from the first module side. This creates an essentially triangular gusset in an inter-cell region between two battery cells in a cross-section viewed perpendicular to the second direction. Due to the varying thickness, an adaptation to this geometry is advantageously possible. This makes it possible, for example, for the fire protection element to penetrate into this gusset region and at least partially fill it, which in turn allows an improved sealing between the cells to be achieved.

Due to the varying thickness in the first direction, it is also advantageously possible to make the fire protection element thinner, for example in the regions of the releasable cell degassing openings, than in other regions. This allows the fire protection element to be easily and reliably penetrated by a gas escaping from such a cell. In other regions of the fire protection element that are not directly opposite such a releasable cell degassing opening, the fire protection element can be made thicker in order to provide better tolerance compensation and a better sealing effect.

According to a further advantageous embodiment of the invention, the degassing region of the first module side has a plurality of first and second module regions which are arranged alternately next to one another in the first direction, wherein the first module regions each comprise a releasable cell degassing opening and the second regions form an inter-cell region which comprises a boundary region between two mutually adjacent battery cells of the battery module. Furthermore, the fire protection element has in particular a plurality of first and second regions which are arranged alternately next to one another in the first direction, wherein a respective first region of the fire protection element corresponds to a first module region and a respective second region of the fire protection element corresponds to a respective inter-cell region, wherein the first and second regions differ in the at least one property.

Thus, the regions of the fire protection element that are directly opposite a releasable cell degassing opening can advantageously be designed with different properties than the regions that are not directly opposite such a releasable cell degassing opening, but rather lie in an inter-cell region. Here, other properties are advantageous, for example a good sealing effect, while in the first regions of the fire protection element, for example, easy penetration of gases from the battery cells hitting the fire protection element is advantageous.

According to a further advantageous embodiment of the invention, the first regions are each formed with a local material weakening, in particular a groove and/or taper and/or notch, along at least one predetermined breaking line. In principle, it is conceivable that the first regions are also designed globally with a generally reduced thickness or wall thickness. However, the first regions may also only have a local weakening of the material along a line or a linear structure. This advantageously allows a predetermined breaking point to be formed in a respective first region. This allows a gas escaping from a thermally runaway cell to easily and reliably penetrate the fire protection element in the first region.

According to a further advantageous embodiment of the invention, the first regions have a smaller thickness, in particular a smaller average thickness, than the second regions, in particular wherein the second regions taper in the third direction when viewed in a cross section perpendicular to the second direction. The thickness in the first regions can be constant or variable. In principle, however, it is advantageous if the thickness is at least on average smaller in the first regions than in the second regions, so that the first regions can be reliably penetrated by a gas escaping from a cell. The increased thickness in the second regions has the advantage of an improved sealing effect. In addition, the geometry of the second regions, which tapers in the third direction, has the great advantage that the second regions are geometrically optimally adapted to the geometry of the first module side in the degassing region. The second regions can thus penetrate into the gusset regions between the cells and thus seal the cells from each other in a particularly advantageous manner.

According to a further advantageous embodiment of the invention, the first regions have a lower porosity and/or pore density than the second regions. Since the second regions in particular are intended to provide a good sealing effect, a high porosity or high pore density is advantageous. Due to the increased compression behavior, the second regions can geometrically adapt or form much better to the opposite corresponding regions of the first module side and nestle against them. This also facilitates production, since, for example, the geometry of the above-mentioned second regions with the taper in the third direction does not have to be exactly adapted to the geometry of the gusset regions between the battery cells, since the elasticity and compressibility, especially in these second regions, provide a particularly good tolerance compensation option.

According to a further advantageous embodiment of the invention, the fire protection element is divided into a third, fourth and fifth region in the second direction, wherein the fourth region is arranged between the third and fifth regions, wherein the third region in the second direction is at least as wide as the at least one releasable cell degassing opening, wherein the fire protection element in the third region additionally has a fire protection layer which is arranged on the foam injection molding layer and extends in particular in the first direction over the at least one releasable cell degassing opening. If the battery module comprises multiple battery cells, the fire protection layer extends in the first direction in particular over all releasable cell degassing openings of these cells.

Such an additional fire protection layer can advantageously provide an additional protective and shielding effect, especially with regard to the reflected gases described above. Thus, on the one hand, the fire protection element in the first regions can be very easily penetrated by gases escaping from a battery cell, and on the other hand, neighboring cells and their releasable cell degassing openings can be very well protected from reflected gas components by the fire protection element by means of this additional fire protection layer.

It is further advantageous if the fire protection layer comprises at least one of the following layers: a plastic film, a graphite layer, a textile fiber semi-finished product, in particular with ceramic fibers and/or glass fibers and/or carbon fibers and/or aramid fibers, and a lacquer layer and/or fire protection coating. The lacquer layer and/or the fire protection coating can also be applied as a coating on the plastic film. All of these layers can advantageously provide additional fire protection. These layers are designed in such a way that they are particularly temperature-resistant and at least temporarily shield any hot gases that occur. This means that the foam injection molding layer behind it can be advantageously protected from damage and/or melting by this additional fire protection layer.

Therefore, it represents a further very advantageous embodiment of the invention if the fire protection layer is arranged on a side of the foam injection molding layer facing away from the first module side. As a result, the fire protection layer advantageously protects against reflected gas components that, for example, hit the fire protection element from inside the degassing channel. Preferably, the fire protection element does not have such a fire protection layer on the side of the foam injection molding layer facing the first module side. This is advantageous because it allows gas escaping from a cell to easily penetrate the fire protection element.

Such a fire protection layer can, for example, be added to the foam injection molding layer at the same time as it is being produced in the injection molding process, for example by providing this fire protection layer as an insert in the injection molding tool. The produced foam injection molding layer can also be subsequently provided with such a fire protection layer, for example by coating it or by gluing it to the foam injection molding layer or something similar.

In addition, the fire protection layer can also be limited to the fourth region, i.e. it does not extend into the third and/or fifth region. This saves material and costs and allows fire protection functionality to be provided exactly where it is needed. In addition, this makes it possible to provide such a fire protection layer as an insert in the injection molding process and to simultaneously inject the foam layer onto a part of the housing component during production, e.g. in the third and/or fifth region.

According to a further advantageous embodiment of the invention, the foam injection molding layer is therefore injection molded onto the passage region of the housing component. The housing component or at least a part thereof can also be inserted into the injection molding tool as an insert so that the foam injection molding layer can be molded directly onto the housing component. Thus, the foam injection molding layer can be fixed to the housing component at the same time during the production of the foam injection molding layer.

According to a further advantageous embodiment of the invention, the foam injection molding layer has a smooth, closed, non-open-pored outer skin. This makes the outer skin advantageously gas-tight. This can also be advantageously realized using an injection molding process. The outer sides of the foam injection molding layer adjacent to the injection molding tool can thus advantageously be designed without open pores and thus as a smooth, closed, non-open-pored outer skin.

Furthermore, the invention also relates to a battery for a motor vehicle which comprises a battery arrangement according to the invention or one of its embodiments. The battery can be a high-voltage battery. The battery may also comprise multiple battery arrangements according to the invention and/or battery arrangements according to exemplary embodiments of the invention.

Furthermore, the invention relates to a motor vehicle which comprises a battery arrangement according to the invention or one of its embodiments and/or comprises a battery according to the invention or one of its embodiments.

The motor vehicle according to the invention is preferably designed as an automobile, in particular as a passenger car or truck, or as a passenger bus or motorcycle.

Furthermore, the invention also relates to a method for producing a fire protection element for arrangement between a degassing region of a first module side of a battery module and a passage region of a housing component. The fire protection element is formed with an elastic foam injection molding layer which is produced by means of an injection molding process, and in particular in an injection molding process, wherein at least two regions of the fire protection element are formed with at least one differing property.

Furthermore, the invention also relates to a method for producing a battery arrangement, wherein a battery module is provided which comprises at least one battery cell and a first module side, wherein the first module side has a degassing region in which at least one releasable cell degassing opening of the at least one battery cell is arranged, wherein a housing component is provided which comprises a passage region which comprises at least one at least releasable opening, wherein the housing component is arranged relative to the battery module in such a way that the passage region is directly opposite the degassing region in such a way that the at least one at least releasable opening is opposite the at least one releasable cell degassing opening, and wherein a fire protection element is arranged between the degassing region and the passage region, which element covers the at least releasable opening and the releasable cell degassing opening. The fire protection element is formed with an elastic foam injection molding layer which is produced by means of an injection molding process, in particular in an injection molding process, wherein at least two regions of the fire protection element are formed with at least one differing property.

The advantages described in relation to the battery arrangement according to the invention and its embodiments apply in the same way to the method according to the invention for producing a fire protection element and to the method according to the invention for producing the battery arrangement.

To produce the foam injection molding layer for the fire protection element, a base material, in particular a thermoplastic soft material, can be foamed in the injection molding tool. Foaming can be done chemically and/or physically. Preferably, a blowing agent is used for foaming during the injection molding process. Optionally, the injection molding process can also be carried out with a global and/or local expansion stroke. This allows the degree of foaming to be modified and/or adjusted globally or in specific regions. During the expansion stroke, the closed tool halves or tool parts are moved apart while the matrix material with the optional blowing agent and the optional at least one filler have already been filled into the cavity formed between the tool halves or tool parts. The tool parts can also be moved apart to varying degrees in order to produce locally different degrees of foaming. To produce locally different pore densities, at least one half of the injection molding tool can be designed with multiple parts and the multiple parts can be designed to be movable independently of one another. For this purpose, for example, a plunge edge tool with several, i.e. at least two, movable segments can be used, which allow a locally different expansion stroke.

The injection molding process can optionally also be carried out on a metallic insert, which at the same time forms part of the subsequent cooling, i.e. the housing component.

The invention also includes developments of the method according to the invention, which have features as have already been described in conjunction with the developments of the battery arrangement according to the invention. For this reason, the corresponding developments of the method according to the invention are not repeated here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic cross-sectional illustration of a battery arrangement according to an exemplary embodiment of the invention;

FIG. 2 shows a schematic representation of a battery arrangement on the first module side of a battery module of a battery arrangement according to an exemplary embodiment of the invention.

FIG. 3 shows a schematic cross-sectional illustration of a fire protection element for a battery arrangement according to an exemplary embodiment of the invention;

FIG. 4 shows a schematic cross-sectional illustration of a battery arrangement according to an exemplary embodiment of the invention;

FIG. 5 shows a schematic representation of a plan view of the housing component with a fire protection element arranged thereon, according to an exemplary embodiment of the invention; and

FIG. 6 shows a schematic representation of the housing side with fire protection elements arranged thereon, according to a further exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

The coordinate systems shown are in particular Cartesian coordinate systems. In particular, the y-direction shown corresponds to the previously defined first direction, the x-direction shown to the previously defined second direction, and the z-direction shown to the previously defined third direction.

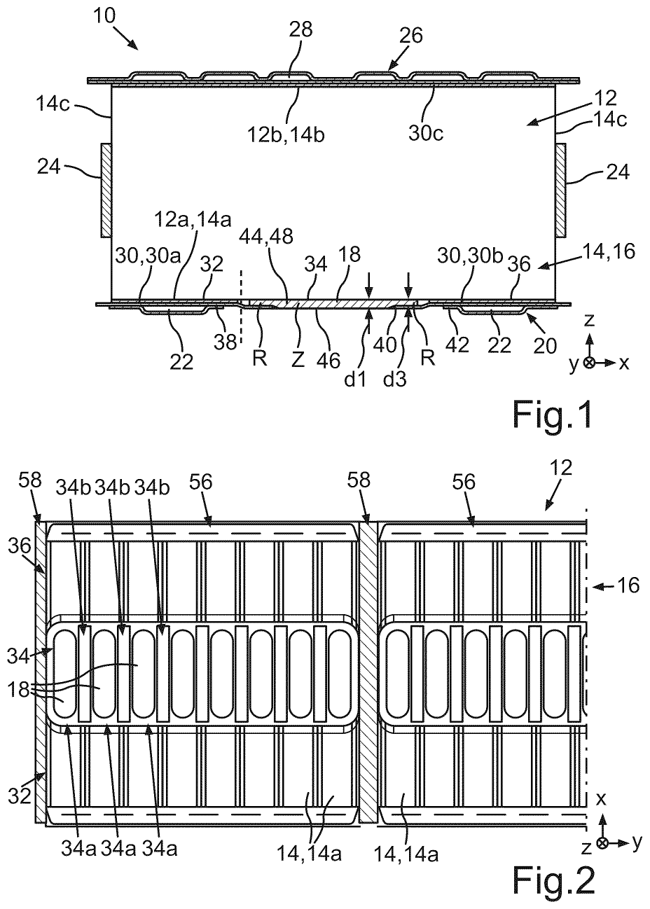

FIG. 1 shows a schematic cross-sectional illustration of a battery arrangement 10 according to an exemplary embodiment of the invention. The battery arrangement 10 comprises a battery module 12, which in turn comprises multiple battery cells 14, in particular prismatic battery cells 14. The battery cells 14 are arranged next to one another in a stacking direction y and thus form a cell stack 16, of which only one battery cell 14 can be seen in the present illustration. The battery module 12 has a first module side 12a and an opposite second module side 12b. The two module sides 12a, 12b are opposite each other with respect to the z-direction shown. The battery cell 14 has a corresponding first cell side 14a and a second cell side 14b, opposite with respect to the z direction. A releasable cell degassing opening 18 of the battery cell 14 is arranged on the first cell side 14a. The first cell side 14a is part of the first module side 12a and the second cell side 14b is part of the second model side 12b. In addition, the cell 14 comprises two cell poles 24, which in the present example are arranged laterally on the cell 14, that is, on the cell sides 14c and 14d delimiting the cell 14 in and against the x-direction.

Furthermore, the battery arrangement 10 comprises a housing component 20, which in this example is simultaneously designed as a cooling device 20, for example in the form of a cooling plate 20, which comprises integrated cooling channels 22 through which a coolant can flow. In addition, the battery arrangement 10 in the present example also comprises a second cooling device 26, which can also be designed as a cooling plate 26 and also comprises cooling channels 28 through which a coolant can flow. The housing component 20 is arranged on the underside of the battery module 12, specifically on the first module side 12a, and the second cooling device 26 is arranged on the second module side 12b. In order to improve the thermal connection of the cooling device 20 to the first module side 12a, a thermal interface layer 30 can be arranged between the first module side 12a and the cooling device 20. In particular, in this example it is designed in two parts and comprises a first layer part 30a and a second layer part 30b. In addition, in the present example, such a thermal interface layer 30c is also arranged between the second cooling device 26 and the second module side 12b.

For a better description, the first module side 12a and the housing component 20 are divided into three sub-regions, wherein this division is illustrated by the dashed lines shown. The first module side 12a is thus divided into a first region 32, a second region 34 and a third region 36. The cooling device 20 can be correspondingly divided into a first region 38, a second region 40 and a third region 42. The respective regions extend, for example, over the entire battery module 12 in or against the y-direction. The respective second regions 34, 40 are located between the first regions 32, 38 and in third regions 36, 42. The second region 34 of the first module side 12a is the region in which the releasable cell degassing openings 18 of the battery cells 14 of the module 12 are arranged. The second region 34 is therefore also referred to as the degassing region 34.

Furthermore, the housing component 20 has no cooling channels 22 in the second region 40, which represents a passage region 40. Instead, this passage region 40 is formed with at least releasable openings 46, which can also be called predetermined passage points 46. These predetermined passage points 46 can be provided by openings in the housing component 20 or an element of this housing component 20, which can be covered by a covering layer, for example by a film or the like. The covering layer for covering the openings 46 also seals the openings. The at least releasable openings 46 can have positions and/or geometries corresponding to the releasable cell degassing openings 18. These at least releasable openings 46 are each located directly opposite an associated releasable cell degassing opening 18.

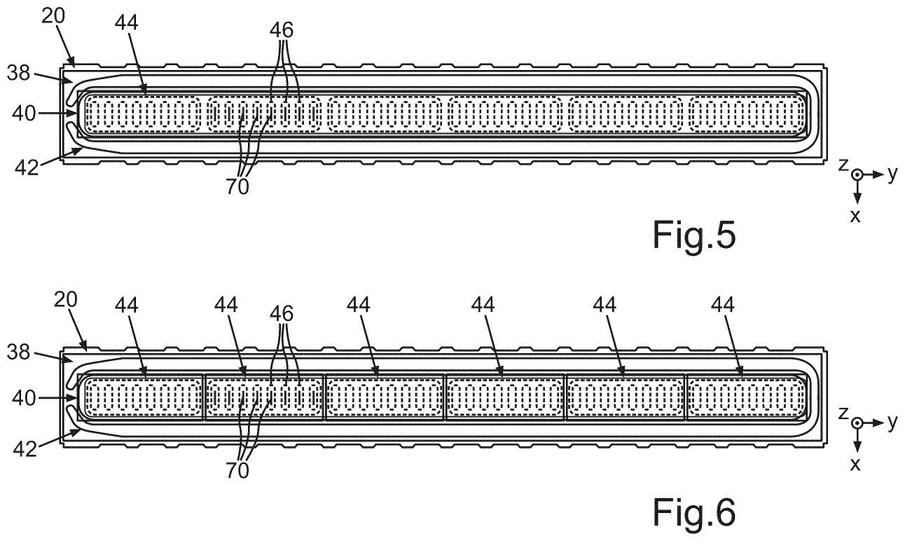

These openings or predetermined passage regions 46 are also shown again in FIG. 5 and FIG. 6 in a schematic plan view of the housing component, in this case the cooling plate 20.

Between the second degassing region 34 of the first module side 12a and the passage region 40, a fire protection element 44 is now advantageously arranged, which can also be referred to as a heat shield. This is arranged below the respective cell vents 18 and can extend in or against the y-direction continuously over several cell vents 18 or all cell vents 18 of the module 12.

The design of the fire protection element 44 is now explained in more detail below.

FIG. 2 shows a schematic representation in plan view of the first module side 12a of a battery module 12 of a battery arrangement 10 according to an exemplary embodiment of the invention. The battery module 12 can be designed as described with reference to FIG. 1. In particular, the respective undersides 14a of the respective battery cells 14 and their respective releasable cell degassing openings 18 can be seen, which are arranged in a central region of the first module side 12a, which is also referred to as degassing region 34. The cell stack 16 comprised by the battery module 12 can also be divided into several cell groups 56. The cell groups 56 can be separated from each other in the y-direction by respective partition walls 58. If the fire protection element 44 to be used is arranged as intended in the intermediate space 48 (cf. FIG. 1) between the degassing region 34 and the passage region 46, it preferably covers the entire degassing region 34 or at least almost the entire degassing region 34, and in particular at least all of the releasable cell degassing openings 18. A single fire protection element 44 can cover all of the cell degassing openings 18 of an entire module 12 or of an entire cell stack 16, or a separate fire protection element 44 of this type can also be provided for each cell group 56, for example. This will be explained in more detail later with reference to FIG. 5 and FIG. 6.

The degassing region 34 can now be divided into further sub-regions. This comprises in particular first regions 34a, in each of which a releasable cell degassing opening 18 is arranged, and second regions 34b, which represent inter-cell regions 34b and comprise the boundary region between two adjacent battery cells 14. The first and second regions 34a, 34b alternate in the y-direction.

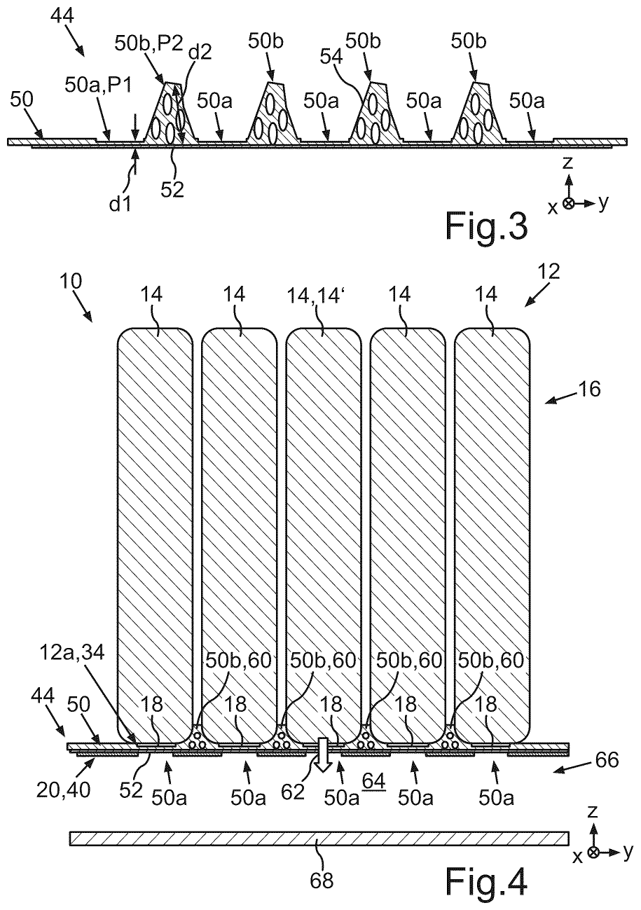

FIG. 3 shows a schematic cross-sectional illustration of a fire protection element 44 according to an exemplary embodiment of the invention. The fire protection element 44 comprises, on the one hand, an elastic foam injection molding layer 50. In addition, the fire protection element 44 in this example also comprises an additional fire protection layer 52, which is arranged below the foam injection molding layer 50, and thus on a side facing away from the battery module 12. With respect to the illustrated x-direction, this additional fire protection layer 52 has a width that is at least as large as the width of the releasable cell degassing openings 18. The fire protection element 44 is also arranged on the first module side 12a in such a way that the fire protection layer 52 covers the respective releasable cell degassing openings 18 in the x-direction. However, the fire protection layer 52 does not necessarily have to extend over the entire width of the fire protection element 44 or the foam layer 50. This allows particularly good protection to be provided for the cell vents 18 and outside this cell vent region the foam layer 50 can provide very good sealing and tolerance-compensating properties. This allows the fire protection element 44 to be provided with locally different properties. However, different properties can also be provided in other regions of the fire protection element 44. For example, the foam injection molding layer 50 itself can be designed differently in certain regions, for example with a different porosity and/or thickness. In this example, the thickness of the foam injection molding layer varies in the y-direction. The fire protection element 44 and the corresponding foam layer 50 can also be divided in the y-direction into several first and second regions 50a, 50b. The first regions 50a correspond to the first regions 34a of the first module side 12a and the second regions 50b of the fire protection element 44 correspond to the inter-cell regions 34b of the first module side 12a.

The first regions 50a of the fire protection element 44 have a first thickness d1 in the z-direction, which is smaller than a second thickness d2 of the second regions 50b. The thickness d1, d2 can refer to an average thickness or a maximum thickness in the respective regions 50a, 50b. In addition, the foam layer 50 has a first porosity P1 in the first regions 50a and a porosity P2 in the second regions 50b, which differs from the first porosity P1, in particular is larger. In other words, the second regions 50b are formed with a higher pore density P2 than the first regions 50a. This also allows the injection-molded component, namely the fire protection element 44 or the foam layer 50, to be provided with different properties in different regions. In particular, this makes it possible to provide different properties in the various functional regions, for example “foamed” or “compact”, “back-injected with an additional material” or similar, as well as to implement corresponding changes in the wall thickness, i.e. the thickness d1, d2. As described, an optional strip-shaped additional layer can be back-injected as fire protection, namely the fire protection layer 52.

The fire protection element 44 can, as also shown in FIG. 1, have two edge regions R which delimit it in and against the x-direction shown, as well as a central region Z which is arranged between these edge regions R. The fire protection element 44 can have in the z-direction in the edge regions R a thickness d3 that is smaller than the thickness d1 in the central region. As a result, the fire protection element 44 is also much better adapted to the geometry of the intermediate space 48.

The elastic foam layer 50, as shown in FIG. 3, for example, can advantageously be produced in a foam injection molding process. In particular, the entire fire protection element 44 can be manufactured in such an injection molding process. To form the foam layer 50, a thermoplastic soft component or a thermoplastic soft material is preferably used. Examples include thermoplastic elastomers, thermoplastic polyurethanes and thermoplastic vulcanizates. Such thermoplastic soft materials can be used in an injection molding process using, for example, blowing agents to provide a permanently elastic injection molded body, namely the foam layer 50, with thicknesses d1, d2 in the range of, for example, 1.5 mm to 4 mm inclusive. These thicknesses d1, d2 can refer both to the uncompressed state, as shown in FIG. 3, and to the compressed state when the fire protection element 44 is installed in the battery module arrangement 10. In the illustration shown in FIG. 3, the foam regions of the foam layer 50 are thus not yet compressed.

The fire protection layer 52, which can comprise, for example, an additional plastic film or several additional plastic films and/or a graphite layer and/or textile semi-finished products made of ceramic fibers, glass fibers, or the like, preferably does not extend over the entire width of the fire protection element 44 in the x-direction, but is less wide, but at least as wide as the cell vents 18. The fire protection layer, i.e. the fire protection layer 52, sits in the manufactured battery arrangement 10 on the side of the foam layer 50 facing away from the cell. Optionally, the foam layer 50 can also be provided as a foam layer 50 filled with at least one filler. As a result, the foam layer 50 can be provided with further advantageous properties. For example, its heat resistance can be increased by using ceramic fillers or particles or similar. The optionally filled foam structure 50 is also permanently elastic. Due to the elasticity of the foam layer 50, tolerances in the high-voltage module or the battery module arrangement 10 between the heat shield, i.e. the fire protection element 44 and the adjacent components, namely the first module side 12a and the housing component 20, can advantageously be compensated with regard to thickness. The component 44, in particular the foam layer 50, has a closed foam structure, i.e. it has no outside pores, so that it is gas-tight. In other words, the foam layer 50 may have an outer skin 54 that is smooth and not open-cell or non-porous. In addition, the foam layer 50 can be designed as a gradient foam. This means that starting from the outer skin 54 towards the center of the foam layer 50, the porosity and/or pore size, which can also be referred to as cell size, increases.

FIG. 4 shows a schematic cross-sectional view of a battery arrangement 10 perpendicular to the illustrated x-direction. Here it can be seen how the second regions 50b advantageously fit into the gusset regions 60 between the cells 14. Thus, the fire protection element 44 is particularly well adapted to the geometries of the first module side 12a. Above all, a particularly good seal between the cells 14 can be provided by this fire protection layer 44. If, for example, a thermal runaway occurs in one of the battery cells 14, as illustrated here by way of example for cell 14′, gas 62 escapes from the then exposed cell degassing opening 18 of this cell 14′. This can penetrate the fire protection element 44 in the associated first region 50a and thereby be introduced into the interior 64 of a gas discharge channel 66. The first regions 50a of the fire protection element 44 can therefore represent compact regions 50a, which are therefore less foamed or not foamed at all. This allows the first regions 50a to be made particularly thin. This makes them easier to penetrate by the incident gas stream 62 exiting from a cell 14. The foamed regions 50b serve to adapt and seal the cells 14 in the radius region of the cell cups or cell housings, namely in the gusset regions 60. In order to further increase the penetrability in the regions 50a, these can also be designed with local predetermined breaking lines 70 (cf. FIG. 5 and FIG. 6). For reasons of clarity, these are illustrated in FIG. 5 and FIG. 6 as examples only for some of the regions 50a of the fire protection element 44 or only for some fire protection elements 44.

The gas discharge channel 66, as can be seen in FIG. 4, for example, and which can also be referred to as a degassing channel 66, can also have a degassing channel wall 68 opposite the housing component 20 with respect to the z-direction. In the event of a reflection of part of the escaping gas flow 62 on this wall 68, the cell vents 18 of the adjacent cells 14 in particular can be very well protected by the fire protection element 44 and in particular by the fire protection layer 52. The advantageous geometric adaptation of the foam layer 50 also leads to very good tolerance-compensating and sealing properties between the cells 14, so that this also makes it more difficult for the neighboring cells 14 to become involved.

FIG. 5 and FIG. 6 each show a schematic representation of a top view of the housing component 20 designed as a cooling plate 20, on which in the example shown in FIG. 5 a fire protection element 44 extending over all predetermined passage points 46 of the cell stack 16 is arranged in the y-direction, and in the example shown in FIG. 6 multiple fire protection elements 44 are arranged next to one another in the y-direction in the passage region 40 of the housing component 20. The individual fire protection elements 44 can correspond to respective cell groups 56, as described with reference to FIG. 2. This serves only as an example of the positioning of the parts above the cooling plate 20 with vent openings, i.e. the predetermined passage points 46. A multi-part design as well as a single strip is possible. Various combinations of these are also possible.

Overall, the examples show how the invention can provide an injection molded heat shield for a high-voltage module.

1. A battery arrangement, comprising: a housing component and a battery module, which comprises at least one battery cell and a first module side which faces the housing component, wherein the first module side has a degassing region in which at least one releasable cell degassing opening of the at least one battery cell is arranged, wherein the housing component comprises a passage region which comprises at least one at least releasable opening, wherein the passage region is located directly opposite the degassing region in such a way that the at least one at least releasable opening is opposite the at least one releasable cell degassing opening, and
a fire protection element arranged in an intermediate space between the degassing region and the passage region, which element covers the at least releasable opening and the releasable cell degassing opening, wherein the fire protection element is formed with an elastic foam injection molding layer and comprises at least two regions which differ in at least one property.

2. The battery arrangement according to claim 1, wherein the foam injection molding layer comprises a foamed, thermoplastic soft component, in particular thermoplastic elastomers and/or thermoplastic polyurethanes and/or thermoplastic vulcanizates.

3. The battery arrangement according to claim 1, wherein the at least one property represents:
a porosity of the foam injection molding layer; and/or
a thickness of the fire protection element; and/or
a layer structure of the fire protection element.

4. The battery arrangement according to claim 1, wherein the fire protection element has a length in a first direction, a width in a second direction and a thickness in a third direction,
wherein the fire protection element has a central region and two edge regions with respect to the second direction, wherein a thickness of the fire protection element in the edge regions is smaller than in the central region and/or
wherein the fire protection element has a thickness varying in the first direction, in particular a periodically varying thickness.

5. The battery arrangement according to claim 1, wherein the degassing region of the first module side has multiple first and second module regions which are arranged alternately next to one another in the first direction,
wherein the first module regions each comprise a releasable cell degassing opening and the second regions form an inter-cell region which comprises a boundary region between two mutually adjacent battery cells of the battery module,
the fire protection element has multiple first and second regions which are arranged alternately next to one another in the first direction, wherein a respective first region of the fire protection element corresponds to a first module region and a respective second region of the fire protection element corresponds to a respective inter-cell region, wherein the first and second regions differ in the at least one property.

6. The battery arrangement according to claim 1, wherein the first regions are each formed with a local material weakening, in particular a groove and/or taper and/or notch, along at least one predetermined breaking line; and/or
the first regions have a smaller thickness than the second regions, in particular wherein the second regions taper in the third direction when viewed in a cross-section perpendicular to the second direction.

7. The battery arrangement according to claim 1, wherein the first regions have a lower porosity and/or pore density than the second regions.

8. The battery arrangement according to claim 1, wherein the fire protection element is divided into a third, fourth and fifth region in the second direction, wherein the fourth region is arranged between the third and fifth region, the third region is at least as wide in the second direction as the at least one releasable cell degassing opening, wherein the fire protection element in the third region additionally has a fire protection layer which is arranged on the foam injection molding layer and extends in particular in the first direction over the at least one releasable cell degassing opening, in particular wherein the fire protection layer comprises at least one of the following layers:
a plastic film,
a graphite layer,
a textile fiber semi-finished product, in particular with ceramic fibers and/or glass fibers and/or carbon fibers and/or aramid fibers,
a lacquer layer.

9. The battery arrangement according to claim 1, wherein the fire protection layer is arranged on a side of the foam injection molding layer facing away from the first module side.

10. A method for producing a fire protection element for arrangement between a degassing region of a first module side of a battery module and a passage region of a housing component,
wherein the fire protection element is formed with an elastic foam injection molding layer which is produced by means of an injection molding process, wherein at least two regions of the fire protection element are formed with at least one different property.

11. The battery arrangement according to claim 2, wherein the at least one property represents:
a porosity of the foam injection molding layer; and/or
a thickness of the fire protection element; and/or
a layer structure of the fire protection element.

12. The battery arrangement according to claim 2, wherein the fire protection element has a length in a first direction, a width in a second direction and a thickness in a third direction,
wherein the fire protection element has a central region and two edge regions with respect to the second direction, wherein a thickness of the fire protection element in the edge regions is smaller than in the central region and/or
wherein the fire protection element has a thickness varying in the first direction, in particular a periodically varying thickness.

13. The battery arrangement according to claim 3, wherein the fire protection element has a length in a first direction, a width in a second direction and a thickness in a third direction,
wherein the fire protection element has a central region and two edge regions with respect to the second direction, wherein a thickness of the fire protection element in the edge regions is smaller than in the central region and/or
wherein the fire protection element has a thickness varying in the first direction, in particular a periodically varying thickness.

14. The battery arrangement according to claim 2, wherein the degassing region of the first module side has multiple first and second module regions which are arranged alternately next to one another in the first direction,
wherein the first module regions each comprise a releasable cell degassing opening and the second regions form an inter-cell region which comprises a boundary region between two mutually adjacent battery cells of the battery module,
the fire protection element has multiple first and second regions which are arranged alternately next to one another in the first direction, wherein a respective first region of the fire protection element corresponds to a first module region and a respective second region of the fire protection element corresponds to a respective inter-cell region, wherein the first and second regions differ in the at least one property.

15. The battery arrangement according to claim 3, wherein the degassing region of the first module side has multiple first and second module regions which are arranged alternately next to one another in the first direction,
wherein the first module regions each comprise a releasable cell degassing opening and the second regions form an inter-cell region which comprises a boundary region between two mutually adjacent battery cells of the battery module,
the fire protection element has multiple first and second regions which are arranged alternately next to one another in the first direction, wherein a respective first region of the fire protection element corresponds to a first module region and a respective second region of the fire protection element corresponds to a respective inter-cell region, wherein the first and second regions differ in the at least one property.

16. The battery arrangement according to claim 4, wherein the degassing region of the first module side has multiple first and second module regions which are arranged alternately next to one another in the first direction,
wherein the first module regions each comprise a releasable cell degassing opening and the second regions form an inter-cell region which comprises a boundary region between two mutually adjacent battery cells of the battery module,
the fire protection element has multiple first and second regions which are arranged alternately next to one another in the first direction, wherein a respective first region of the fire protection element corresponds to a first module region and a respective second region of the fire protection element corresponds to a respective inter-cell region, wherein the first and second regions differ in the at least one property.

17. The battery arrangement according to claim 2, wherein the first regions are each formed with a local material weakening, in particular a groove and/or taper and/or notch, along at least one predetermined breaking line; and/or
the first regions have a smaller thickness than the second regions, in particular wherein the second regions taper in the third direction when viewed in a cross-section perpendicular to the second direction.

18. The battery arrangement according to claim 3, wherein the first regions are each formed with a local material weakening, in particular a groove and/or taper and/or notch, along at least one predetermined breaking line; and/or
the first regions have a smaller thickness than the second regions, in particular wherein the second regions taper in the third direction when viewed in a cross-section perpendicular to the second direction.

19. The battery arrangement according to claim 4, wherein the first regions are each formed with a local material weakening, in particular a groove and/or taper and/or notch, along at least one predetermined breaking line; and/or
the first regions have a smaller thickness than the second regions, in particular wherein the second regions taper in the third direction when viewed in a cross-section perpendicular to the second direction.

20. The battery arrangement according to claim 5, wherein the first regions are each formed with a local material weakening, in particular a groove and/or taper and/or notch, along at least one predetermined breaking line; and/or
the first regions have a smaller thickness than the second regions, in particular wherein the second regions taper in the third direction when viewed in a cross-section perpendicular to the second direction.
